(19) United States
(12) Patent Application Publication
(10) Pub. No.: US 2026/0231270 A1
(43) Pub. Date: Aug. 6, 2026

(54) DEVICE AND METHOD OF COMMUNICATION

(71) Applicant: NEC Corporation, Tokyo (JP)

(72) Inventors: Zonghui XIE, Beijing (CN); You LI, Beijing (CN); Rao SHI, Beijing (CN); Gang WANG, Beijing (CN)

(73) Assignee: NEC Corporation, Tokyo (JP)

(21) Appl. No.: 19/147,744

(22) PCT Filed: Feb. 3, 2023
(86) PCT No.: PCT/CN2023/074451

§ 371 Date: Jul. 14, 2025

(51) Int. Cl. H04W 76/20; H04L 1/00; H04W 68/02; H04W 72/1273; H04W 72/231; H04W 76/19

(52) U.S. Cl. CPC H04W 76/20; H04L 1/0061; H04W 68/02; H04W 72/1273; H04W 72/231; H04W 76/19

(57) ABSTRACT

Embodiments of the present disclosure relate to devices and methods of communication. In one aspect, an access network device may transmit a message to a terminal device in an idle or inactive state. If the message indicates an A-IoT communication, the terminal device initiates the A-IoT communication with a set of A-IoT devices based on the message. In this way, an A-IoT communication may be initiated.

### TECHNICAL FIELD

Embodiments of the present disclosure generally relate to the field of telecommunication, and in particular, to devices and methods of communication involving an ambient-Internet of things (A-IoT) device.

### BACKGROUND

Recently, it has been proposed to incorporate an A-IoT device into a cellular network communication. However, a solution of cellular communication involving an A-IoT device (also referred to as A-IoT communication herein) is still unclear and needs to be further developed.

### SUMMARY

In general, embodiments of the present disclosure provide methods, devices and computer storage media for A-IoT communication.

In a first aspect, there is provided a terminal device. The terminal device comprises a processor. The processor is configured to cause the terminal device to: receive, in an idle or inactive state, a message from an access network device; and in accordance with a determination that the message indicates an ambient Internet of things (A-IoT) communication, initiate, based on the message, the A-IoT communication with a set of A-IoT devices.

In a second aspect, there is provided an access network device. The access network device comprises a processor. The processor is configured to cause the access network device to: transmit, to a terminal device in an idle or inactive state, a message indicating an ambient Internet of things (A-IoT) communication.

In a third aspect, there is provided a method of communication. The method comprises: receiving, at a terminal device in an idle or inactive state, a message from an access network device; and in accordance with a determination that the message indicates an ambient Internet of things (A-IoT) communication, initiating, based on the message, the A-IoT communication with a set of A-IoT devices.

In a fourth aspect, there is provided a method of communication. The method comprises: transmitting, at an access network device and to a terminal device in an idle or inactive state, a message indicating an ambient Internet of things (A-IoT) communication.

In a fifth aspect, there is provided a computer readable medium having instructions stored thereon. The instructions, when executed on at least one processor, cause the at least one processor to perform the method according to any of the third to fourth aspects of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which some embodiments of the present disclosure can be implemented;

FIG. 2 illustrates a schematic diagram illustrating a process of initiating an A-IoT communication according to embodiments of the present disclosure;

FIG. 3 illustrates an example method of communication implemented at a terminal device in accordance with some embodiments of the present disclosure;

FIG. 4 illustrates an example method of communication implemented at an access network device in accordance with some embodiments of the present disclosure; and

FIG. 5 illustrates a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” may refer to a core network device or an access network device. The term “core network device” refers to any device or entity that provides access and mobility management function (AMF), network exposure function (NEF), authentication server function (AUSF), unified data management (UDM), session management function (SMF), user plane function (UPF), a location management function (LMF), etc., In other embodiments, the core network device may be any other suitable device or entity providing any other suitable functionality.

As used herein, the term “access network device” refers to a device which is capable of providing or hosting a cell or coverage where terminal devices can communicate. Examples of an access network device include, but not limited to, a satellite, a unmanned aerial systems (UAS) platform, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the context of the present disclosure, the term “A-IoT” may be interchangeably used with “passive IoT”. The term “A-IoT device” may refer to a device comprising an energy harvesting module and a backscattering module. The A-IoT device may receive an energy supply signal or command via the energy harvesting module and backscatter a signal via the backscattering module. Some example use cases of the A-IoT device are listed below.

| High Level | | |
|---|---|---|
| Function | Reference Use Cases | Brief Scenario Description |
| Inventory | Automated | Items are inventoried either at |
| | warehousing | specific locations or when |
| | Airport terminal/ | passing through a gate, within |
| | shipping port | a warehouse. |
| Object | Finding remote lost item | Location of lost item is |
| finding | Personal belongings | determined by UEs/network. |
| | finding | |
| Local sensor | Smart home | Reports from one or more |
| reporting | Smart bridge health | sensors located on a bridge (e.g. |
| | monitoring | tilt, vibration, water level) |
| Wide area | Fresh food supply chain | Temperature and/or location |
| sensor | | reports are collected for each |
| reporting | | item e.g. on a regular basis (in a |
| | | food distribution chain i.e. items |
| | | are not stationary) |
| Proximity | Indoor positioning in | Proximity to a fixed item is used |
| detection/ | shopping center | to determine position in an |
| positioning | Museum guide | indoor area. |
| Device state | Smart agriculture | Network is able to control |
| control | | greenhouse conditions in |
| | | response to sensors (e.g. |
| | | irrigation or ventilation) |

In the context of the present disclosure, the term “command UE” may refer to a terminal device transmitting a command to an A-IoT device to implement select, inventory or access (e.g., read and write) to the A-IoT device. The term “excitation UE” may refer to a terminal device providing an excitation signal or energy to an A-IoT device. After receiving the excitation signal, the A-IoT device may generate an induced current, and then receive information and send information through energy obtained by the induced current. It is to be understood that the names “command UE” and “excitation UE” merely are examples, and any other suitable names are also feasible.

In the context of the present disclosure, the term “an identity of a terminal device” may refer to an identity of the terminal device allocated by upper layers of the terminal device or an identity of the terminal device assigned by a network. The term “an identity of a terminal device allocated by upper layers” may be based on 5G-S-TMSI of the terminal device. For example, the identity allocated by upper layers may be 5G-S-TMSI mod 4096 or 5G-S-TMSI mod 1024. The term “an identity of a terminal device assigned by an access network device” may be a full inactive-radio network temporary identity (full I-RNTI) or a short inactive-radio network temporary identity (short I-RNTI) of the terminal device. Herein, the term “an identity of a terminal device assigned by an access network device” may be interchangeably used with “an identity of a terminal device assigned by a network”.

Embodiments of the present disclosure provide a solution of cellular communication involving an A-IoT device (also referred to as A-IoT communication herein). In the solution, an access network device may transmit a message to a terminal device in an idle or inactive state. If the message indicates an A-IoT communication, the terminal device initiates the A-IoT communication with a set of A-IoT devices based on the message. In this way, an A-IoT communication may be initiated.

Principles and implementations of the present disclosure will be described in detail below with reference to the figures.

### Example of Communication Network

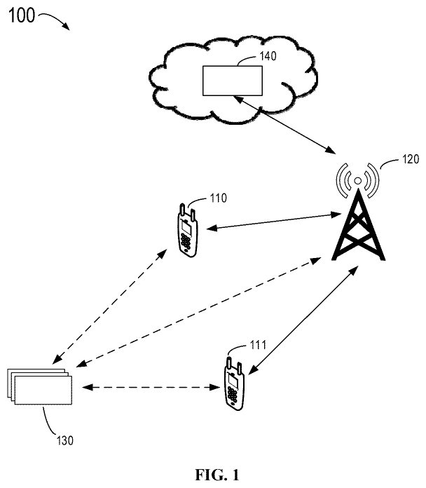

FIG. 1 illustrates a schematic diagram of an example communication network 100 in which some embodiments of the present disclosure can be implemented. As shown in FIG. 1, the communication network 100 may include terminal devices 110 and 111 and an access network device 120. In some embodiments, the access network device 120 may provide one or more serving cells (not shown) to serve the terminal devices 110 and 111.

As shown in FIG. 1, the communication network 100 may further include an A-IoT device 130. In some embodiments, the access network device 120 and the A-IoT device 130 may communicate with each other. In some embodiments, one of the terminal devices 110 and 111 and the A-IoT device 130 may communicate with each other. In some embodiments, the A-IoT device 130 may communicate with one of the terminal devices 110 and 111 in a forward link, and may communicate with the access network device 120 in a backward link. In some embodiments, the A-IoT device 130 may communicate with the access network device 120 in a forward link, and may communicate with one of the terminal devices 110 and 111 in a backward link.

As shown in FIG. 1, the communication network 100 may further include a core network device 140. In some embodiments, the access network device 120 and the core network device 140 may communicate with each other.

It is to be understood that the number of devices in FIG. 1 is given for the purpose of illustration without suggesting any limitations to the present disclosure. The communication network 100 may include any suitable number of access network devices and/or terminal devices and/or A-IoT devices and/or core network devices adapted for implementing implementations of the present disclosure.

The terminal device 110 may communicate with the access network device 120 via a Uu interface. The access network device 120 may communicate with the core network device 140 via an Ng interface. The communications in the communication network 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

In some scenarios, the A-IoT device 130 may communicate with an A-IoT server (not shown) via a cellular network comprising the terminal device 110 and/or 111, and the access network device 120 and the core network device 140. The A-IoT communication may be triggered by a network. For some scenarios where the A-IoT device 130 is connected to the network via the terminal device 110, how to initiate the A-IoT communication if the terminal device 110 is in an idle or inactive state or any other states (e.g., in a state defined for A-IoT communications or in a connected state with paging) needs to be specified.

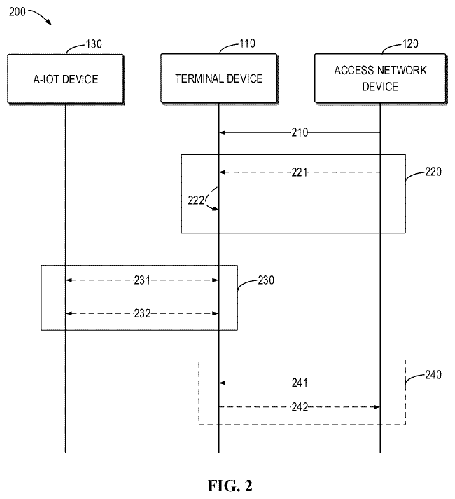

Embodiments of the present disclosure provide a solution of initiating an A-IoT communication so as to overcome the above and other potential issues. The detailed description will be made with reference to FIG. 2 below.

### Example Implementation of Initiating of A-Iot Communication

FIG. 2 illustrates a schematic diagram illustrating a process 200 of initiating an A-IoT communication according to embodiments of the present disclosure. For the purpose of discussion, the process 200 will be described with reference to FIG. 1. The process 200 may involve the terminal device 110, the access network device 120 and the A-IoT device 130 as illustrated in FIG. 1. It is to be understood that the steps and the order of the steps in FIG. 2 are merely for illustration, and not for limitation. For example, the order of the steps may be changed. Some of the steps may be omitted or any other suitable additional steps may be added. In this example, it is assumed that the terminal device 110 is in an idle or inactive state. However, it is to be understood that embodiments of the present disclosure may also be carried out in case that the terminal device 110 is in any other suitable states (e.g., in a state defined for A-IoT communications or in a connected state with paging).

As shown in FIG. 2, the access network device 120 may transmit 210 a message to the terminal device 110 in an idle or inactive state. In some embodiments, the message may indicate a communication (i.e., an A-IoT communication) with a set of A-IoT devices (e.g., the A-IoT device 130). In some embodiments, the message may indicate a communication with the terminal device 110.

The terminal device 110 may determine 220 whether the message indicates the A-IoT communication. In some embodiments, the access network device 120 may also transmit 221, to the terminal device 110, an indication indicating whether the message is for the A-IoT communication or whether the message is only for the A-IoT communication. Based on the indication, the terminal device 110 may determine 222 whether the message is for the A-IoT communication.

In some embodiments, the message may be a paging message. In these embodiments, the indication may be comprised in a paging record. For example, the paging message may be configured as below:

| | |
|---|---|
| PagingRecord ::= | SEQUENCE { |
| ue-Identity | PagingUE-Identity, |
| access Type | ENUMERATED {non3GPP}, |
| A-IoTTransmissions | ENUMERATED {A-IoT transmission, A-IoT |

transmission only}
}

In this example, information element (IE) “A-IoTTransmissions” may indicate that the paging message is for the A-IoT communication or only for the A-IoT communication.

Alternatively, the indication may be comprised as a paging cause. For example, the paging message may be configured as below:

| | |
|---|---|
| PagingRecordList-v1700 ::= | SEQUENCE (SIZE(1..maxNrofPageRec)) OF |

PagingRecord-v1700

| | |
|---|---|
| PagingRecord-v1700 ::= | SEQUENCE { |

| | |
|---|---|
| pagingCause-r17 | ENUMERATED {voice, A-IoT transmission, A-IoT |

transmission only}
}

In this example, the paging cause “A-IoT transmission” or “A-IoT transmission only” may indicate that the paging message is for the A-IoT communication or only for the A-IoT communication. It is to be understood that the indication may adopt any other suitable forms.

In some embodiments where the terminal device 110 is in the idle state, the terminal device 110 may receive a CN paging message indicating the A-IoT communication. In some embodiments where the terminal device 110 is in the inactive state, the terminal device 110 may receive a RAN or CN paging message indicating the A-IoT communication. It is to be understood that the paging message is merely an example, and any other suitable messages existing or to be developed in future are also feasible.

In some embodiments, the message may comprise an indication of the A-IoT communication. In some embodiments, the indication of the A-IoT communication may be associated with an identity of the terminal device 110. In some embodiments where the message is a paging message, the indication of the A-IoT communication may be introduced in a paging record for the terminal device 110. The paging message may be configured as below.

| | |
|---|---|
| PagingRecord ::= | SEQUENCE { |
| ue-Identity | PagingUE-Identity, |
| accessType | ENUMERATED {non3GPP} |
| A-IoTTransmissions | ENUMERATED {true} |

}

In this example, IE “A-IoTTransmissions” with true may indicate the A-IoT communication.

In some embodiments, the indication of the A-IoT communication may be comprised in the message as an access type. In some embodiments where the message is a paging message, an access type indicating the A-IoT communication may be introduced in a paging record for the terminal device 110. The paging message may be configured as below.

| | |
|---|---|
| PagingRecord ::= | SEQUENCE |
| ue-Identity | PagingUE-Identity, |
| accessType | ENUMERATED { A-IoTTransmissions} |

}

In some embodiments, the indication of the A-IoT communication may be comprised in the message as a cause. In some embodiments where the message is a paging message, a paging cause indicating the A-IoT communication may be introduced. The paging message may be configured as below.

| | |
|---|---|
| PagingRecordList-vN ::= | SEQUENCE (SIZE(1..maxNrofPageRec)) OF |

pagingRecord-vN

| | |
|---|---|
| PagingRecord-vN ::= | SEQUENCE { |
| pagingCause-rN | ENUMERATED { A-IoT transmission} |

}

In this example, if pagingRecordList-vN is comprised, pagingRecordList-vN may comprise the same number of entries listed in the same order as in pagingRecordList (associate to paging for terminal device). If the paging cause field is set to “A-IoT transmission”, it implies that the corresponding paging entry is for the A-IoT communication. It is to be understood that this is merely an example, and any other suitable forms are also feasible.

In some embodiments, the indication of the A-IoT communication may be comprised in the message by causing an identity of an A-IoT device (e.g., the A-IoT device 130) to be comprised in a notification list. In other words, the notification list may be introduced to include the identity of the A-IoT device which is notified by a network to have the A-IoT communication. In this case, the notification list may be used to indicate multiple A-IoT devices to perform A-IoT communication, and identities of the multiple A-IoT devices are managed by the terminal device or stored in the terminal device. In some embodiments where the message is a paging message, a notification list dedicated for A-IoT communication may be introduced. The paging message may be configured as below.

| PagingAIoTNotificationList ::= | SEQUENCE |
|---|---|
| (SIZE(1..maxNrofPagingAIoTNotificationList)) OF PagingAIoTNotification | |
| PagingAIoTNotification ::= | SEQUENCE { |
| AIoT-Identity | PagingAIoT-Identity |

}

In this example, IE “PagingAIoTNotificationList” with IE “AIoT-Identity” may be introduced. It is to be understood that this is merely an example, and any other suitable forms are also feasible.

Alternatively, an additional paging record list may be introduced for A-IoT communication. The paging message may be configured as below.

| | |
|---|---|
| PagingRecordList-AloT ::= | SEQUENCE (SIZE(1..maxNrofAIoTPageRec)) |

OF PagingRecord-AloT

| | |
|---|---|
| PagingRecord-AloT ::= | SEQUENCE { |
| AIoT-Identity | AIoT-Identity |

}

In this example, a size of paging record lists may be modified to introduce the indication of the A-IoT communication.

In some embodiments, the indication of the A-IoT communication may be comprised in the message by causing an identity of the terminal device 110 to be comprised in a notification list. In other words, the notification list may be introduced to include the identity of the terminal device which is notified by a network to have the A-IoT communication. The A-IoT communication may be for one or more A-IoT devices. In some embodiments where the message is a paging message, a notification list dedicated for A-IoT communication may be introduced. The paging message may be configured as below.

| PagingAIoTNotificationList ::= | SEQUENCE |
|---|---|
| (SIZE(1..maxNrofPagingAIoTNotificationList)) OF PagingAIoTNotification | |
| PagingAIoTNotification ::= | SEQUENCE { |
| UE-Identity | PagingUE-Identity |

}

In this example, IE “PagingAIoTNotificationList” with IE “UE-Identity” may be introduced. It is to be understood that this is merely an example, and any other suitable forms are also feasible.

In some additional or alternative embodiments, the message may comprise a command for the A-IoT communication. In other words, the command may implicitly indicate an A-IoT communication for one or more A-IoT devices. In some embodiments, the command for the A-IoT communication may be associated with an identity of the terminal device 110. In some embodiments where the message is a paging message, the indication of the A-IoT communication and corresponding A-IoT command may be introduced in a paging record for the terminal device 110. The paging message may be configured as below.

| | |
|---|---|
| PagingRecord ::= | SEQUENCE { |
| ue-Identity | PagingUE-Identity, |
| accessType | ENUMERATED {non3GPP} |
| A-IoTTransmissions | ENUMERATED {Command 1, Command 2, |

Command 3,...}
}

In this example, IE “A-IoTTransmissions” with one command may be introduced. It is to be understood that this is merely an example, and any other suitable forms are also feasible.

In some embodiments, the command for the A-IoT communication may be comprised in the message as a cause. In some embodiments where the message is a paging message, a paging cause indicating the A-IoT communication and corresponding A-IoT command may be introduced. The paging message may be configured as below.

| | |
|---|---|
| PagingRecordList-vN ::= | SEQUENCE (SIZE(1..maxNrofPageRec)) OF |

PagingRecord-vN

| | |
|---|---|
| PagingRecord-vN ::= | SEQUENCE { |
| pagingCauseAIoT | ENUMERATED {Command 1, Command 2, |

Command 3,...}
}

In this example, if pagingRecordList-vN is comprised, pagingRecordList-vN may comprise the same number of entries listed in the same order as in pagingRecordList (associate to paging for terminal device). If paging cause indicates an A-IoT command, it implies that the corresponding paging entry is for A-IoT transmissions. IE “pagingCauseAIoT” with one command may be introduced. It is to be understood that this is merely an example, and any other suitable forms are also feasible.

In some embodiments, the command for the A-IoT communication may be comprised in the message by causing an identity of the A-IoT device and the command to be comprised in a notification list. In other words, the notification list may be introduced to include the identity of the A-IoT device which is notified by a network to have the A-IoT communication. The notification list may be used to indicate multiple A-IoT devices to perform A-IoT communication, and identities of the multiple A-IoT devices are managed by the terminal device or stored in the terminal device. In some embodiments where the message is a paging message, a notification list dedicated for A-IoT communication may be introduced. The paging message may be configured as below.

| | |
|---|---|
| PagingAIoTNotificationList ::= | SEQUENCE |

(SIZE(1..maxNrofPagingAIoTNotificationList)) OF PagingAIoTNotification

| | |
|---|---|
| PagingAIoTNotification ::= | SEQUENCE { |
| AIoT-Identity | PagingAIoT-Identity |
| A-IoTTransmissions | ENUMERATED {Command 1, Command 2, Command |

3,...}
}

In this example, IE “PagingAIoTNotificationList” may be introduced to include an A-IoT identity and crreponding A-IoT command. It is to be understood that this is merely an example, and any other suitable forms are also feasible.

Alternatively, an additional paging record list may be introduced for A-IoT communication. The paging message may be configured as below.
PagingRecordList-AIoT:: =SEQUENCE (SIZE (1 . . . maxNrofPageRec)) OF PagingRecord-AIoT

| | |
|---|---|
| PagingRecordListAIoT ::= | SEQUENCE (SIZE(1..maxNrofPageRec)) OF |

PagingRecordAIoT

| | |
|---|---|
| PagingRecordList-AloT ::= | SEQUENCE { |
| AIoT-Identity | AIoT-Identity, |
| A-IoTTransmissions | ENUMERATED {Command 1, Command 2, Command |

3,...}
}

In this example, IE “PagingRecordList-AIoT” may be introduced to include an A-IoT identity and crreponding A-IoT command. It is to be understood that this is merely an example, and any other suitable forms are also feasible.

In some embodiments, the command for the A-IoT communication may be comprised in the message by causing an identity of the terminal device 110 and the command to be comprised in a notification list. In other words, the notification list may be introduced to include the identity of the terminal device which is notified by a network to have the A-IoT communication. The A-IoT communication may be for one or more A-IoT devices. In some embodiments where the message is a paging message, a notification list dedicated for A-IoT communication may be introduced. The paging message may be configured as below.

| | |
|---|---|
| PagingAIoTNotificationList ::= | SEQUENCE |

(SIZE(1..maxNrofPagingAIoTNotificationList)) OF PagingAIoTNotification

| | |
|---|---|
| PagingAIoTNotification ::= | SEQUENCE { |

| | |
|---|---|
| UE-Identity | PagingUE-Identity |
| A-IoTTransmissions | ENUMERATED {Command 1, Command 2, Command |

3,...}
}

In this example, IE “PagingAIoTNotificationList” may be introduced to include UE identity and correponding A-IoT command.

It is to be understood that any name, combination of the indication of the A-IoT communication and the command for the A-IoT communication may also be feasible.

In some embodiments, the message may be transmitted on a physical downlink control channel (PDCCH), i.e., in paging DCI, short message indicator or short message. In some embodiments, the message may be transmitted on a physical downlink shared channel (PDSCH) scheduled by the PDCCH, i.e., in paging message.

In some embodiments, the message may be transmitted on a physical downlink control channel (PDCCH) by means of downlink control information (DCI) with cyclic redundancy check (CRC) scrambled by a radio network temporary identity (RNTI) specific to the A-IoT communication. For example, the message may be transmitted on PDCCH by means of DCI format 1_0 with CRC scrambled by a RNTI newly defined for A-IoT paging monitoring. In some embodiments, a short message for A-IoT paging may be defined to carry the message.

In some embodiments, the message may be transmitted on a PDCCH by means of DCI specific to the A-IoT communication. For example, the message may be transmitted on PDCCH by means of a DCI format (e.g., DCI format 1_X) newly defined for A-IoT paging monitoring. In some embodiments, the message may be transmitted in a short message for A-IoT transmission notification. In some embodiments, a short message for A-IoT paging may be defined to carry the message.

In some embodiments, the message may be transmitted on a physical downlink shared channel (PDSCH) scheduled by the DCI with CRC scrambled by the RNTI specific to the A-IoT communication. For example, the message may be transmitted on PDSCH scheduled by DCI format 1_0 with CRC scrambled by a RNTI newly defined for A-IoT paging monitoring.

In some embodiments, the message may be transmitted on a PDSCH scheduled by the DCI specific to the A-IoT communication. For example, the message may be transmitted on PDSCH scheduled by a DCI format (e.g., DCI format 1_X) newly defined for A-IoT paging monitoring.

In this way, a trigger for A-IoT communication may be monitored using separate DCI or RNTI. With a separate code domain radio resource, the trigger for A-IoT communication may be differentiated by a terminal device.

Continue to refer to FIG. 2, if the received message indicates the A-IoT communication, the terminal device 110 may initiate 230 the A-IoT communication with a set of A-IoT devices (e.g., the A-IoT device 130) based on the message.

In some embodiments, if an indication or command of the A-IoT communication is comprised in the message, the terminal device 110 may initiate the A-IoT communication. For example, an example procedure may be described as below.
1> if the UE is acting as an A-IoT command UE, for each of the PagingRecord, if any, included in the Paging message:
   2> if the A-IoTTransmissions included in the PagingRecord is set to true:
      3> initiate the A-IoT procedure.

As another example, an example procedure may be described as below.
1> if in RRC_IDLE, for each of the PagingRecord, if any, included in the Paging message,
   2> if the ue-Identity included in the PagingRecord matches the UE identity allocated by upper layers:
      3> if the A-IoTTransmissions included in the PagingRecord is set to true or if the A-IoT command is included in the PagingRecord:
         4> initiate the A-IoT procedure;
1> if in RRC_INACTIVE, for each of the PagingRecord, if any, included in the Paging message
   2> if the ue-Identity included in the PagingRecord matches the UE's stored fullI-RNTI (RAN-paging), or:
   2> if the ue-Identity included in the PagingRecord matches the UE identity allocated by upper layers (CN-paging):
      3> if the A-IoTTransmissions included in the PagingRecord is set to true or if the A-IoT command is included in the PagingRecord:
         4> initiate the A-IoT procedure.

In some embodiments, if a cause for the message indicates the A-IoT communication or a command for the A-IoT communication, the terminal device 110 may initiate the A-IoT communication. For example, an example procedure may be described as below.
1> if the UE is acting as an A-IoT command UE, for each of the paging cause, if any, included in the Paging message:
   2> if the paging cause is set to “A-IoT transmission”:
      3> initiate the A-IoT procedure.

As another example, an example procedure may be described as below.
1> if in RRC_IDLE, for each of the PagingRecord, if any, included in the Paging message,
   2> if the ue-Identity included in the PagingRecord matches the UE identity allocated by upper layers:
      3> if upper layers indicate the support of paging cause:
         4> forward the ue-Identity, access Type (if present) and paging cause (if determined) to the upper layers;
         4> if the paging cause is set to “A-IoT transmission” or if the A-IoT command is included in the paging cause:
         5> initiate the A-IoT procedure;
      3> else:
         4> forward the ue-Identity and access Type (if present) to the upper layers;
1> if in RRC_INACTIVE, for each of the PagingRecord, if any, included in the Paging message
   2> if the ue-Identity included in the PagingRecord matches the UE's stored fullI-RNTI (RAN-paging):
      3> if upper layers indicate the support of paging cause, and
      3> the paging cause is set to “A-IoT transmission” or the A-IoT command is included in the paging cause:
         4> initiate the A-IoT procedure;
         4> forward the ue-Identity and paging cause to the upper layers;
   2> else if the ue-Identity included in the PagingRecord matches the UE identity allocated by upper layers (CN-paging):
      3> if upper layers indicate the support of paging cause:
         4> forward the ue-Identity, access Type (if present) and paging cause (if determined) to the upper layers;
      3> else:
         4> forward the ue-Identity and access Type (if present) to the upper layers;
      3> the paging cause is set to “A-IoT transmission” or the A-IoT command is included in the paging cause:
         4> initiate the A-IoT procedure;
      3> else
         4> perform the actions upon going to RRC_IDLE.

In some embodiments, if an identity of an A-IoT device comprised in a notification list matches an identity of an A-IoT device managed or stored by the terminal device, the terminal device 110 may initiate the A-IoT communication. For example, an example procedure may be described as below.
1> if the UE is acting as an A-IoT command UE, for each of the PagingRecord-AIoT, if any, included in the Paging message:
   2> if the A-IoT Identity included in the PagingRecordList-AIoT (or PagingRecord-AIoT) matches the A-IoT identity managed by the UE/stored in the UE:
      3> initiate the A-IoT procedure.

As another example, an example procedure may be described as below.
1> if the UE is acting as an A-IoT command UE, for each of the PagingRecord/paging cause/PagingRecord-AIoT/PagingAIoTNotification, if any, included in the Paging message:
   2> if the AIoT-Identity included in the PagingAIoTNotification matches the A-IoT identity managed by the UE/stored in the UE:
      3> (indicate the lower layer to) initiate the A-IoT procedure.

As still another example, an example procedure may be described as below.
1> if in RRC_IDLE, for each of the PagingRecord, if any, included in the Paging message,
   2> if the ue-Identity included in the PagingRecord matches the UE identity allocated by upper layers:
      3> if the A-IoT Identity included in the PagingRecordList-AIoT (or PagingRecord-AIoT) matches the A-IoT identity managed by the UE/stored in the UE:
         4> initiate the A-IoT procedure;
1> if in RRC_INACTIVE, for each of the PagingRecord, if any, included in the Paging message
   2> if the ue-Identity included in the PagingRecord matches the UE's stored fullI-RNTI (RAN-paging), or
   2> if the ue-Identity included in the PagingRecord matches the UE identity allocated by upper layers (CN-paging):
      3> if the A-IoT Identity included in the PagingRecordList-AIoT (or PagingRecord-AIoT) matches the A-IoT identity managed by the UE/stored in the UE:
         4> initiate the A-IoT procedure.

As yet another example, an example procedure may be described as below.
1> if in RRC_IDLE/RRC_INACTIVE, for each of the PagingRecord-AIoT, if any, included in the Paging message,
   2> if the A-IoT Identity included in the PagingRecordList-AIoT (PagingRecord-A-IoT) matches the A-IoT identity managed by the UE/stored in the UE:
      3> initiate the A-IoT procedure.

As still yet another example, an example procedure may be described as below.
1> if in RRC_IDLE, for each of the PagingAIoTNotification, if any, included in the Paging message,
   2> if the AIoT-Identity included in the PagingAIoTNotification matches the A-IoT identity managed by the UE/stored in the UE:
      3> initiate the A-IoT procedure;
1> if in RRC_INACTIVE, for each of the PagingAIoTNotification, if any, included in the Paging message
   2> if the AIoT-Identity included in the PagingAIoTNotification matches the A-IoT identity managed by the UE/stored in the UE:
      3> initiate the A-IoT procedure.

In some embodiments, if an identity of the terminal device 110 comprised in a notification list matches an identity of the terminal device 110 allocated by upper layers or assigned by the access network device 120, the terminal device 110 may initiate the A-IoT communication. For example, an example procedure may be described as below.
1> if the UE is acting as an A-IoT command UE, for each of the PagingRecord/paging cause/PagingRecord-AIoT/PagingAIoTNotification, if any, included in the Paging message:
   2> if the ue-Identity included in the PagingAIoTNotification matches the UE identity allocated by upper layers:
      3> initiate the A-IoT procedure.

As another example, an example procedure may be described as below.
1> if in RRC_IDLE, for each of the PagingAIoTNotification, if any, included in the Paging message,
   2> if the ue-Identity included in the PagingAIoTNotification matches the UE identity allocated by upper layers:
      3> initiate the A-IoT procedure;
1> if in RRC_INACTIVE, for each of the PagingAIoTNotification, if any, included in the Paging message
   2> if the ue-Identity included in the PagingAIoTNotification matches the UE's stored fullI-RNTI (RAN-paging), or
   2> if the ue-Identity included in the PagingAIoTNotification matches the UE identity allocated by upper layers (CN-paging):
      3> initiate the A-IoT procedure.

In some embodiments, if a command for the A-IoT communication is comprised in the message, the terminal device 110 may initiate the A-IoT communication. For example, an example procedure may be described as below.
1> if the UE is acting as an A-IoT command UE, for each of the PagingRecord, if any, included in the Paging message:
   2> if the A-IoT command is included in the PagingRecord:
      3> initiate the A-IoT procedure.

In some embodiments, if a cause for the message indicates the command for the A-IoT communication, the terminal device 110 may initiate the A-IoT communication. For example, an example procedure may be described as below.
1> if the UE is acting as an A-IoT command UE, for each of the paging cause, if any, included in the Paging message:
   2> if the A-IoT command is included in the paging cause:
      3> initiate the A-IoT procedure.

Continue to refer to FIG. 2, in some embodiments, the terminal device 110 may initiate 231 an inventory of the set of A-IoT devices. In other words, upon reception of the message indicating the A-IoT communication, the terminal device 110 may initiate the inventory procedure.

In some embodiments, the terminal device 110 may perform 232 the A-IoT communication based on a command for the A-IoT communication. In this case, the terminal device 110 may firstly initiate an inventory of the set of A-IoT devices and then perform the A-IoT communication based on the command.

In some embodiments where the terminal device 110 initiates the A-IoT procedure, comprising initiating an inventory or performing the A-IoT communication based on the command, the terminal device 110 may indicate a lower layer (e.g., MAC layer) to initiate the A-IoT communication. In some embodiments, the terminal device 110 may forward information of the A-IoT communication from a lower layer (e.g., RRC layer) to upper layers of the terminal device 110, and then the A-IoT communication may be initiated by the upper layers. In some embodiments, the terminal device 110 may forward, from the lower layer to the upper layers, at least one of an identity of the terminal device 110, access type or a cause comprised in the message. In some embodiments, the terminal device 110 may not perform actions upon going to an idle state.

In some embodiments, if feedback from one or more A-IoT devices for the A-IoT transmission procedure is received (e.g., from lower layers, may be a physical layer or MAC layer), indicate to upper layers the A-IoT transmission was successful. In this way the terminal device 110 may receive the identification information (e.g., from the A-IoT device(s) in the coverage of the terminal device 110) or move the A-IoT device to acknowledgement status successfully or receive the feedback for the command or receive the A-IoT communication data for the command.

In some embodiments, if the A-IoT communication is initiated, the terminal device 110 may start a timer. In some embodiments, if a feedback is received from the set of A-IoT devices while the timer is running, the terminal device 110 may determine that the A-IoT communication is successfully completed. In some embodiments, if the timer expires, the terminal device 110 may determine that the A-IoT communication is failed.

For illustration, an example procedure may be described as below:
after initiating an A-IoT procedure, UE should monitor the feedback using Response WindowTimer;
while ResponseWindowTimer is running, if feedback from one or more A-IoT devices for the A-IoT procedure is received (e.g., from lower layers), UE indicates (e.g., to upper layers) the A-IoT procedure was successful;
if the ResponseWindowTimer expires, UE indicates (e.g., to upper layers) the A-IoT procedure was failed or not completed.

In some embodiments, the terminal device 110 may receive, from the access network device 120, a mapping between commands for the A-IoT communication and configuration sets. In some embodiments, the mapping may be delivered when UE is in a connected state or leaves the connected state. In some embodiments, if a command for the A-IoT communication is received, the terminal device 110 may determine, based on the mapping, a configuration set corresponding to the command, and initiate the A-IoT communication based on the configuration set.

Continue to refer to FIG. 2, the terminal device 110 may transmit 240 a result of the A-IoT communication to the access network device 120. The result may comprise at least one of the following: an indication of success or failure of the A-IoT communication; the A-IoT identification information; inventory results; or the A-IoT data corresponding to the A-IoT commands. In some embodiments, the result of the A-IoT communication may be delivered to the access network device 120 during transmissions in a connected state. In some embodiments, the result of the A-IoT communication may be delivered to the access network device 120 upon entering a connected state (i.e., during random access). In some embodiments, the result of the A-IoT communication may be delivered to the access network device 120 by small data transmission (SDT) procedure, for example, using mobile originated early data transmission (MO-EDT), random access small data transmission (RA-SDT) or configured grant small data transmission (CG-SDT). If the result of the A-IoT communication is delivered by RA-SDT, the result of the A-IoT communication may be transmitted by message 3.

In some embodiments, if the result of the A-IoT communication (e.g., an indication that the A-IoT communication is successful, an indication that the A-IoT communication is failed, or contents for the A-IoT communication) is determined, the terminal device 110 may initiate an RRC connection establishment procedure. In some embodiments, the terminal device 110 may initiate the RRC establishment procedure with an establishment cause indicating that the RRC connection establishment procedure is initiated upon complete of the A-IoT communication. In other words, the establishment cause indicates that the RRC connection establishment procedure is initiated after receiving the message indicating the A-IoT communication.

In some embodiments, if the result of the A-IoT communication is determined, the terminal device 110 may initiate a RRC connection resume procedure. In some embodiments, the terminal device 110 may initiate the RRC connection resume procedure with a resume cause indicating that the RRC connection resume procedure is initiated upon complete of the A-IoT communication. In other words, the resume cause indicates that the RRC connection resume procedure is initiated after receiving the message indicating the A-IoT communication.

In some embodiments, during or after the terminal device 110 enters a connected state, the terminal device 110 may further receive a command for the A-IoT communication. In some embodiments, the further command for the A-IoT communication may be delivered by SDT. In some embodiments, the command for the A-IoT communication may be associated with multiple A-IoT devices, which are determined by a previously inventory procedure or A-IoT communication procedure.

Continue to refer to FIG. 2, in some embodiments, the access network device 120 may transmit 241, to the terminal device 110, a further indication indicating whether a response to the message is to be transmitted. In some embodiments, the further indication may be transmitted via system information. In some embodiments, the further indication may be transmitted via the message indicating the A-IoT communication. In some embodiments, the further indication may indicate whether a response to the message is to be transmitted when the A-IoT communication is complete (include success case and failure case). In some embodiments, the further indication may indicate whether a response to the message is to be transmitted when the A-IoT communication is failed. In some embodiments, if the further indication indicates that the response is to be transmitted, the terminal device 110 may transmit 242 the result of the A-IoT communication to the access network device 120.

In some embodiments, the terminal device 110 may be in the idle state and the message indicating the A-IoT communication may be a paging message associated with an identity of the terminal device 110 allocated by upper layers of the terminal device 110. The paging message is a CN paging message. In some embodiments, the terminal device 110 may forward at least one of the ue-Identity, access Type, paging cause from the lower layer (i.e., RRC layer) to the upper layers. In some embodiments, the terminal device 110 may forward information of complete of the A-IoT communication from the lower layer (i.e., RRC layer) to the upper layers. If the A-IoT communication fails and no response to the paging message is to be transmitted, the terminal device 110 may remain in the idle state. In this case, the information of complete of the A-IoT communication may indicate the failure of the A-IoT communication or indicate that there is no need to initiate a RRC connection establishment procedure. If a response to the paging message is to be transmitted, the terminal device 110 may initiate a RRC connection establishment procedure. In this case, the information of complete of the A-IoT communication may indicate the success of the A-IoT communication or indicate that there is a need to initiate a RRC connection establishment procedure.

For illustration, an example procedure may be described as below.
if in RRC_IDLE, an A-IoT procedure is initiated by CN paging and this is for A-IoT procedure only,
   upon A-IoT procedure failure, and indicated by the NW that UE do not need to response to the paging when A-IoT procedure is failed or do not need to enter RRC_CONNECTED when A-IoT procedure is failed or do not need to indicate the A-IoT procedure failure, UE may remain in RRC_IDLE and forward paging cause (if determined and support) and the A-IoT procedure completion information (e.g., not entering RRC_CONNECTED) to the upper layers; or
   upon A-IoT transmission failure and indicated by the NW that UE need to response, or upon A-IoT procedure successfully complete, and UE need to indicate the NW of A-IoT procedure successfully complete or deliver A-IoT data (e.g., the A-IoT procedure is not FL-control type), UE may forward the ue-Identity, accessType (if present), paging cause (if determined and support) and the A-IoT procedure completion information (e.g., may be different from above one) to the upper layers.

In some embodiments, the terminal device 110 may be in the inactive state and the message indicating the A-IoT communication may be a paging message associated with an identity of the terminal device 110 assigned by the access network device 120. The paging message is a RAN paging message. In some embodiments, the terminal device 110 may forward at least one of the ue-Identity, accessType, paging cause from the lower layer (i.e., RRC layer) to the upper layers. In some embodiments, the terminal device 110 may forward information of complete of the A-IoT communication from the lower layer (i.e., RRC layer) to the upper layers. If the A-IoT communication fails and no response to the paging message is to be transmitted, the terminal device 110 may remain in the inactive state. In this case, the information of complete of the A-IoT communication may indicate the failure of the A-IoT communication or indicate that there is no need to initiate a RRC connection resume procedure. If a response to the paging message is to be transmitted, the terminal device 110 may initiate a RRC connection resume procedure. In this case, the information of complete of the A-IoT communication may indicate the success of the A-IoT communication or indicate that there is a need to initiate a RRC connection resume procedure.

For illustration, an example procedure may be described as below.
if in RRC_INACTIVE, an A-IoT procedure is initiated by RAN paging and this is for A-IoT procedure only,
   upon A-IoT procedure failure, and indicated by the NW that UE do not need to response to the paging when A-IoT procedure is failed or do not need to enter RRC_CONNECTED when A-IoT procedure is failed or do not need to indicate the A-IoT procedure failure, UE may remain in RRC_INACTIVE, and forwards the ue-Identity, accessType (if present), paging cause (if determined and support) and the A-IoT procedure completion information to the upper layers; or
   upon A-IoT procedure failure, and indicated by the NW that UE need to response, or upon A-IoT procedure successfully complete and UE need to indicate the NW of A-IoT procedure successfully complete or deliver A-IoT data (e.g., the A-IoT procedure is not FL-control type), UE may initiate RRC resume.

In some embodiments, the terminal device 110 may be in the inactive state and the message indicating the A-IoT communication may be the CN paging message associated with the identity of the terminal device 110 allocated by the upper layers. In some embodiments, the terminal device 110 may forward at least one of the ue-Identity, accessType, paging cause from the lower layer (i.e., RRC layer) to the upper layers. In some embodiments, the terminal device 110 may forward information of complete of the A-IoT communication from the lower layer (i.e., RRC layer) to the upper layers. If the A-IoT communication fails and no response to the paging message is to be transmitted, the terminal device 110 may enter the idle state. In this case, the information of complete of the A-IoT communication may indicate the failure of the A-IoT communication or indicate that there is no need to initiate a RRC connection establishment procedure. If a response to the paging message is to be transmitted, the terminal device 110 may initiate a RRC connection establishment procedure. In this case, the information of complete of the A-IoT communication may indicate the success of the A-IoT communication or indicate that there is a need to initiate a RRC connection establishment procedure.

For illustration, an example procedure may be described as below.
if in RRC_INACTIVE, an A-IoT procedure is initiated by CN paging and this is for A-IoT procedure only,
   upon A-IoT procedure failure, and indicated by the NW that UE need to response, or upon (indicated by the lower layer of) A-IoT procedure successfully complete and UE need to indicate the NW of A-IoT procedure successfully complete or deliver A-IoT data (e.g., the A-IoT procedure is not FL-control type), UE may forward the ue-Identity, access Type (if present), paging cause (if determined and support) and the A-IoT procedure completion information to the upper layers, and may go to RRC_IDLE Idle first and then initiate RRC connection establishment (e.g., by upper layers); or
   upon A-IoT procedure failure, and indicated by the NW that UE do not need to response to the paging when A-IoT procedure is failed/do not need to enter RRC_CONNECTED when A-IoT procedure is failed/do not need to indicate the A-IoT procedure failure, UE may go to RRC_IDLE and forward the ue-Identity, access Type (if present), paging cause (if determined and support) and the A-IoT procedure completion information to the upper layers.

In some embodiments, the message may be not for the A-IoT communication only. Upon the complete of the A-IoT communication, the terminal device 110 may forward at least one of the ue-Identity, access Type, paging cause and the A-IoT communication from the lower layer (i.e., RRC layer) to the upper layers. If the terminal device 110 is in the idle state and the message is the CN paging message associated with the identity of the terminal device 110 allocated by the upper layers, the terminal device 110 may initiate a RRC connection establishment procedure. In this case, the information of complete of the A-IoT communication may indicate the success or failure of the A-IoT communication or indicate there is a need to initiate a RRC connection establishment procedure. If the terminal device 110 is in the inactive state and the message is the RAN paging message associated with the identity of the terminal device 110 assigned by the access network device 120, the terminal device 110 may initiate a RRC connection resume procedure. In this case, the information of complete of the A-IoT communication may indicate the success or failure of the A-IoT communication or indicate that there is a need to initiate a RRC connection resume procedure. If the terminal device is in the inactive state and the paging message is the paging associated with the identity of the terminal device allocated by the upper layers and the message is the CN paging message associated with the identity of the terminal device 110 allocated by the upper layers, the terminal device 110 may initiate a RRC connection establishment procedure. In this case, the information of complete of the A-IoT communication may indicate the success or failure of the A-IoT communication or indicate that there is a need to initiate a RRC connection establishment procedure.

For illustration, an example procedure may be described as below.
if in RRC_IDLE, an A-IoT procedure is initiated by CN paging and this is not for A-IoT procedure only, UE may forward at least one of the ue-Identity, accessType (if present), paging cause (if determined and support) and the A-IoT procedure completion information to the upper layers;
if in RRC_INACTIVE, an A-IoT procedure is initiated by RAN paging and this is not for A-IoT procedure only, UE may initiate RRC resume; and
if in RRC_INACTIVE, an A-IoT procedure is initiated by CN paging and this is not for A-IoT procedure only, UE may forward the ue-Identity, access Type (if present), paging cause (if determined and support) and the A-IoT procedure completion information to the upper layers, and may go to RRC_IDLE Idle first and then initiate RRC connection establishment (e.g., by upper layers).

So far, a procedure of an A-IoT communication according to embodiments of the present disclosure may be described. In this way, an A-IoT communication may be initiated effectively.

### Example Implementation of Methods

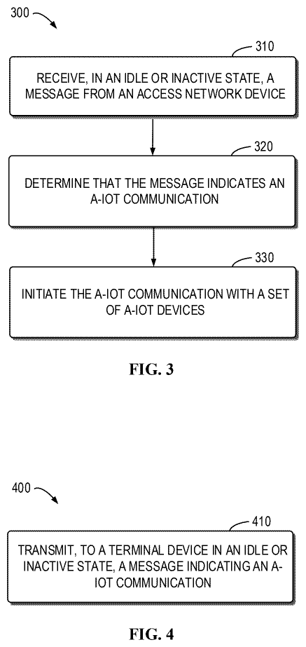

Corresponding to the above processes, embodiments of the present disclosure provide methods of communication implemented at a terminal device and a network device. These methods will be described below with reference to FIGS. 3 to 4.

FIG. 3 illustrates an example method 300 of communication implemented at a terminal device in accordance with some embodiments of the present disclosure. For example, the method 300 may be performed at the terminal device 110 as shown in FIG. 1. For the purpose of discussion, in the following, the method 300 will be described with reference to FIG. 1. It is to be understood that the method 300 may include additional blocks not shown and/or may omit some blocks as shown, and the scope of the present disclosure is not limited in this regard.

At block 310, the terminal device 110 receives, in an idle or inactive state, a message from the access network device 120. In some embodiments, the message may be a paging message. Alternatively, the terminal device 110 may receive the message in any other suitable states, e.g., in a state defined for A-IoT communications or in a connected state with paging.

In some embodiments, the message may comprise at least one of the following: an indication of the A-IoT communication; or a command for the A-IoT communication. In some embodiments, the indication or the command may be comprised in the message by at least one of the following: the indication or the command is associated with an identity of the terminal device; the indication is comprised in the message as an access type; the indication or the command is comprised in the message as a cause; at least one of an identity of an A-IoT device or the command is comprised in a notification list; or at least one of an identity of the terminal device or the command is comprised in the notification list.

In some embodiments, the terminal device 110 may receive the message on a PDCCH by means of DCI with CRC scrambled by a RNTI specific to the A-IoT communication. In some embodiments, the terminal device 110 may receive the message on a PDCCH by means of DCI specific to the A-IoT communication. In some embodiments, the terminal device 110 may receive the message on a PDSCH scheduled by the DCI with CRC scrambled by the RNTI specific to the A-IoT communication. In some embodiments, the terminal device 110 may receive the message on a PDSCH scheduled by the DCI specific to the A-IoT communication.

At block 320, the terminal device 110 determines that the message indicates an A-IoT communication. In some embodiments, the terminal device 110 may receive, from the access network device 120, an indication indicating that the message is for the A-IT communication, and determine that the message indicates the A-IoT communication. In some embodiments where the message is a paging message, the terminal device 110 may receive the indication in a paging record, or receive the indication in a paging cause.

At block 330, the terminal device 110 initiates, based on the message, the A-IoT communication with a set of A-IoT devices.

In some embodiments, if an indication of the A-IoT communication or a command for the A-IoT communication is comprised in the message, the terminal device 110 may initiate the A-IoT communication. If a cause for the message indicates the A-IoT communication or the command, the terminal device 110 may initiate the A-IoT communication. If an identity of an A-IoT device comprised in a notification list matches an identity of an A-IoT device managed by the terminal device, the terminal device 110 may initiate the A-IoT communication. If an identity of the terminal device comprised in a notification list matches an identity of the terminal device allocated by upper layers or assigned by a network, the terminal device 110 may initiate the A-IoT communication.

In some embodiments, the terminal device 110 may initiate an inventory of the set of A-IoT devices. In some embodiments, the terminal device 110 may perform the A-IoT communication based on a command for the A-IoT communication.

In some embodiments, the terminal device 110 may forward information of the A-IoT communication from a lower layer to upper layers of the terminal device 110. In some embodiments, the terminal device 110 may forward, from the lower layer to the upper layers, at least one of an identity of the terminal device 110, access type or a cause comprised in the message.

In some embodiments, if the A-IoT communication is initiated, the terminal device 110 may start a timer. If a feedback is received from the set of A-IoT devices while the timer is running, the terminal device 110 may determine that the A-IoT communication is successfully completed. If the timer expires, the terminal device 110 may determine that the A-IoT communication is failed.

In some embodiments, the terminal device 110 may receive, from the access network device 120, a mapping between commands for the A-IoT communication and configuration sets. If a command for the A-IoT communication is received, the terminal device 110 may determine, based on the mapping, a configuration set corresponding to the command, and initiate the A-IoT communication based on the configuration set.

In some embodiments, the terminal device 110 may transmit a result of the A-IoT communication to the access network device 120. In some embodiments, if the result of the A-IoT communication is determined, the terminal device 110 may initiate an RRC connection establishment or resume procedure. In some embodiments, the terminal device 110 may initiate the RRC connection establishment procedure with an establishment cause indicating that the RRC connection establishment procedure is initiated upon complete of the A-IoT communication. In some embodiments, the terminal device 110 may initiate the RRC connection resume procedure with a resume cause indicating that the RRC connection resume procedure is initiated upon complete of the A-IoT communication.

In some embodiments, the terminal device 110 may receive, from the access network device 120, a further indication indicating whether a response to the message is to be transmitted. If the further indication indicates that the response is to be transmitted, the terminal device 110 may transmit a result of the A-IoT communication to the access network device 120.

In some embodiments, the message is a paging message associated with an identity of the terminal device allocated by the upper layers and is for the A-IoT communication, and the terminal device is in the idle state. In these embodiments, if the A-IoT communication fails and no response to the paging message is to be transmitted, the terminal device 110 may remain in the idle state. If a response to the paging message is to be transmitted, the terminal device 110 may initiate an RRC connection establishment procedure.

In some embodiments, the message is a paging message associated with an identity of the terminal device assigned by the access network device and is for the A-IoT communication, and the terminal device 110 is in the inactive state. In these embodiments, if the A-IoT communication fails and no response to the paging message is to be transmitted, the terminal device 110 may remain in the inactive state. If a response to the paging message is to be transmitted, the terminal device 110 may initiate an RRC connection resume procedure.

In some embodiments, the message is a paging message associated with an identity of the terminal device allocated by the upper layers and is for the A-IoT communication, and the terminal device is in the inactive state. In these embodiments, if the A-IoT communication fails and no response to the paging message is to be transmitted, the terminal device 110 may enter the idle state. If a response to the paging message is to be transmitted, the terminal device 110 may initiate a RRC connection establishment procedure.

In some embodiments, the message is a paging message that is not only for the A-IoT communication. In these embodiments, if the paging message is associated with an identity of the terminal device 110 allocated by the upper layers and the terminal device 110 is in the idle state, the terminal device 110 may forward information of completion of the A-IoT communication from a lower layer to upper layers of the terminal device 110. If the paging message is associated with an identity of the terminal device 110 assigned by the access network device 120 and the terminal device 110 is in the inactive state, the terminal device 110 may initiate a RRC connection resume procedure. If the paging message is the paging associated with the identity of the terminal device 110 allocated by the upper layers and the terminal device 110 is in the inactive state, the terminal device 110 may forward the information of completion of the A-IoT communication from the lower layer to the upper layers.

With the method 300, a terminal device in an idle or inactive state may initiate an A-IoT communication.

FIG. 4 illustrates an example method 400 of communication implemented at an access network device in accordance with some embodiments of the present disclosure. For example, the method 400 may be performed at the access network device 120 as shown in FIG. 1. For the purpose of discussion, in the following, the method 400 will be described with reference to FIG. 1. It is to be understood that the method 400 may include additional blocks not shown and/or may omit some blocks as shown, and the scope of the present disclosure is not limited in this regard.

At block 410, the access network device 120 may transmit, to the terminal device 110 in an idle or inactive state, a message indicating an A-IoT communication. In some embodiments, the message may be a paging message.

In some embodiments, the message may comprise at least one of the following: an indication of the A-IoT communication; or a command for the A-IoT communication.

In some embodiments, the indication or the command is comprised in the message by at least one of the following: the indication or the command is associated with an identity of the terminal device; the indication is comprised in the message as an access type; the indication or the command is comprised in the message as a cause; at least one of an identity of an A-IoT device or the command is comprised in a notification list; or at least one of an identity of the terminal device or the command is comprised in the notification list.

In some embodiments, the access network device 120 may transmit the message on a PDCCH by means of DCI with CRC scrambled by a RNTI specific to the A-IoT communication. In some embodiments, the access network device 120 may transmit the message on a PDCCH by means of DCI specific to the A-IoT communication. In some embodiments, the access network device 120 may transmit the message on a PDSCH scheduled by the DCI with CRC scrambled by the RNTI specific to the A-IoT communication. In some embodiments, the access network device 120 may transmit the message on a PDSCH scheduled by the DCI specific to the A-IoT communication.

In some embodiments, the access network device 120 may transmit, to the terminal device 110 in a connected state, a mapping between commands for the A-IoT communication and configuration sets.

In some embodiments, the access network device 120 may receive, from the terminal device 110, a result of the A-IoT communication. In some embodiments, the access network device 120 may receive a request for RRC connection establishment or resume. In some embodiments, the request for the RRC connection establishment may comprise an establishment cause indicating that the RRC connection establishment procedure is initiated upon complete of the A-IoT communication. In some embodiments, the request for the RRC connection resume comprises a resume cause indicating that the RRC connection resume procedure is initiated upon complete of the A-IoT communication.

In some embodiments, the access network device 120 may transmit, to the terminal device 110, an indication indicating that the message is for the A-IoT communication.

In some embodiments where the message is a paging message, the access network device 120 may cause the indication to be comprised in a paging record, or cause the indication to be comprised in a paging cause.

In some embodiments, the access network device 120 may transmit, to the terminal device 110, a further indication indicating whether a response to the paging message is to be transmitted. If the further indication indicates that the response is to be transmitted, the access network device 120 may receive a result of the A-IoT communication from the terminal device 110.

With the method 400, initiating of an A-IoT communication for a terminal device in an idle or inactive state may be facilitated.

It is to be understood that operations of the methods 300 and 400 correspond to that described with reference to FIG. 2, and thus other details are not repeated here for concise.

### Example Implementation of Device and Apparatus

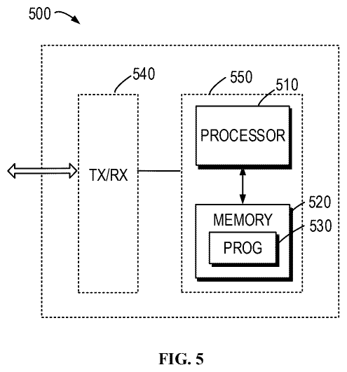

FIG. 5 is a simplified block diagram of a device 500 that is suitable for implementing embodiments of the present disclosure. The device 500 can be considered as a further example implementation of the terminal device 110 or the access network device 120 as shown in FIG. 1. Accordingly, the device 500 can be implemented at or as at least a part of the terminal device 110 or the access network device 120.

As shown, the device 500 includes a processor 510, a memory 520 coupled to the processor 510, a suitable transmitter (TX) and receiver (RX) 540 coupled to the processor 510, and a communication interface coupled to the TX/RX 540. The memory 510 stores at least a part of a program 530. The TX/RX 540 is for bidirectional communications. The TX/RX 540 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 530 is assumed to include program instructions that, when executed by the associated processor 510, enable the device 500 to operate in accordance with the embodiments of the present disclosure, as discussed herein with reference to FIGS. 1 to 4. The embodiments herein may be implemented by computer software executable by the processor 510 of the device 500, or by hardware, or by a combination of software and hardware. The processor 510 may be configured to implement various embodiments of the present disclosure. Furthermore, a combination of the processor 510 and memory 520 may form processing means 550 adapted to implement various embodiments of the present disclosure.

The memory 520 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 520 is shown in the device 500, there may be several physically distinct memory modules in the device 500. The processor 510 may be of any type suitable to the local technical network, and may include one or more of general purpose computers, special purpose computers, microprocessors, digital signal processors (DSPs) and processors based on multicore processor architecture, as non-limiting examples. The device 500 may have multiple processors, such as an application specific integrated circuit chip that is slaved in time to a clock which synchronizes the main processor.

In some embodiments, a terminal device comprises a circuitry configured to: receive, in an idle or inactive state, a message from an access network device; and in accordance with a determination that the message indicates an ambient Internet of things (A-IoT) communication, initiate, based on the message, the A-IoT communication with a set of A-IoT devices.

In some embodiments, an access network device comprises a circuitry configured to: transmit, to a terminal device in an idle or inactive state, a message indicating an ambient Internet of things (A-IoT) communication.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure provide the following solutions.

In one solution, a terminal device comprises a processor configured to cause the terminal device to: receive, in an idle or inactive state, a message from an access network device; and in accordance with a determination that the message indicates an ambient Internet of things (A-IoT) communication, initiate, based on the message, the A-IoT communication with a set of A-IoT devices.

In some embodiments, the message comprises at least one of the following: an indication of the A-IoT communication; or a command for the A-IoT communication.

In some embodiments, the indication or the command is comprised in the message by at least one of the following: the indication or the command is associated with an identity of the terminal device; the indication is comprised in the message as an access type; the indication or the command is comprised in the message as a cause; at least one of an identity of an A-IoT device or the command is comprised in a notification list; or at least one of an identity of the terminal device or the command is comprised in the notification list.

In some embodiments, the terminal device is caused to initiate the A-IoT communication by: in accordance with a determination that an indication of the A-IoT communication or a command for the A-IoT communication is comprised in the message, initiating the A-IoT communication; in accordance with a determination that a cause for the message indicates the A-IoT communication or the command, initiating the A-IoT communication; in accordance with a determination that an identity of an A-IoT device comprised in a notification list matches an identity of an A-IoT device managed by the terminal device, initiating the A-IoT communication; or in accordance with a determination that an identity of the terminal device comprised in a notification list matches an identity of the terminal device allocated by upper layers of the terminal device or assigned by the access network device, initiating the A-IoT communication.

In some embodiments, the terminal device is caused to receive the message by: receiving the message on a physical downlink control channel by means of downlink control information with cyclic redundancy check scrambled by a radio network temporary identity specific to the A-IoT communication; receiving the message on a physical downlink control channel by means of downlink control information specific to the A-IoT communication; receiving the message on a physical downlink shared channel scheduled by the downlink control information with cyclic redundancy check scrambled by the radio network temporary identity specific to the A-IoT communication; or receiving the message on a physical downlink shared channel scheduled by the downlink control information specific to the A-IoT communication.

In some embodiments, the message is a paging message.

In some embodiments, the terminal device is caused to initiate the A-IoT communication by at least one of the following: initiating an inventory of the set of A-IoT devices; or performing the A-IoT communication based on a command for the A-IoT communication.

In some embodiments, the terminal device is caused to initiate the A-IoT communication by at least one of the following: forwarding information of the A-IoT communication from a lower layer to upper layers of the terminal device; or forwarding, from the lower layer to the upper layers, at least one of an identity of the terminal device, access type or a cause comprised in the message.

In some embodiments, the terminal device is further caused to at least one of the following: in accordance with a determination that the A-IoT communication is initiated, start a timer; in accordance with a determination that a feedback is received from the set of A-IoT devices while the timer is running, determine that the A-IoT communication is successfully completed; or in accordance with a determination that the timer expires, determine that the A-IoT communication is failed.

In some embodiments, the terminal device is caused to initiate the A-IoT communication by: receiving, from the access network device, a mapping between commands for the A-IoT communication and configuration sets; in accordance with a determination that a command for the A-IoT communication is received, determining, based on the mapping, a configuration set corresponding to the command; and initiating the A-IoT communication based on the configuration set.

In some embodiments, the terminal device is further caused to: transmit a result of the A-IoT communication to the access network device.

In some embodiments, the terminal device is caused to transmit the result of the A-IoT communication by: in accordance with a determination that the result of the A-IoT communication is determined, initiating a radio resource control connection establishment or resume procedure.

In some embodiments, the terminal device is caused to initiate the radio resource control connection establishment procedure by initiating the radio resource control connection establishment procedure with an establishment cause indicating that the radio resource control connection establishment procedure is initiated upon complete of the A-IoT communication. In some embodiments, the terminal device is caused to initiate the radio resource control connection resume procedure by initiating the radio resource control connection resume procedure with a resume cause indicating that the radio resource control connection resume procedure is initiated upon complete of the A-IoT communication.

In some embodiments, the terminal device is further caused to: receive, from the access network device, an indication indicating that the message is for the A-IoT communication; and determine that the message indicates the A-IoT communication.

In some embodiments, the message is a paging message, and wherein the terminal device is caused to receive the indication by at least one of the following: receiving the indication in a paging record, or receiving the indication in a paging cause.

In some embodiments, the terminal device is further caused to: receive, from the access network device, a further indication indicating whether a response to the message is to be transmitted; and in accordance with a determination that the further indication indicates that the response is to be transmitted, transmit a result of the A-IoT communication to the access network device.

In some embodiments, the message is a paging message associated with an identity of the terminal device allocated by the upper layers and is for the A-IoT communication, and the terminal device is in the idle state, and wherein the terminal device is further caused to: in accordance with a determination that the A-IoT communication fails and no response to the paging message is to be transmitted, remain in the idle state; or in accordance with a determination that a response to the paging message is to be transmitted, initiate a radio resource control connection establishment procedure.

In some embodiments, the message is a paging message associated with an identity of the terminal device assigned by the access network device and is for the A-IoT communication, and the terminal device is in the inactive state, and wherein the terminal device is further caused to: in accordance with a determination that the A-IoT communication fails and no response to the paging message is to be transmitted, remain in the inactive state; or in accordance with a determination that a response to the paging message is to be transmitted, initiate a radio resource control connection resume procedure.

In some embodiments, the message is a paging message associated with an identity of the terminal device allocated by the upper layers and is for the A-IoT communication, and the terminal device is in the inactive state, and wherein the terminal device is further caused to: in accordance with a determination that the A-IoT communication fails and no response to the paging message is to be transmitted, enter the idle state; or in accordance with a determination that a response to the paging message is to be transmitted, initiate a radio resource control connection establishment procedure.

In some embodiments, the message is a paging message that is not only for the A-IoT communication, and wherein the terminal device is further caused to: in accordance with a determination that the paging message is associated with an identity of the terminal device allocated by the upper layers and the terminal device is in the idle state, forward information of completion of the A-IoT communication from a lower layer to upper layers of the terminal device; in accordance with a determination that the paging message is associated with an identity of the terminal device assigned by the access network device and the terminal device is in the inactive state, initiate a radio resource control connection resume procedure; or in accordance with a determination that the paging message is the paging associated with the identity of the terminal device allocated by the upper layers and the terminal device is in the inactive state, forward the information of completion of the A-IoT communication from the lower layer to the upper layers.

In another solution, an access network device comprises a processor configured to cause the access network device to: transmit, to a terminal device in an idle or inactive state, a message indicating an ambient Internet of things (A-IoT) communication.

In some embodiments, the message comprises at least one of the following: an indication of the A-IoT communication; or a command for the A-IoT communication.

In some embodiments, the indication or the command is comprised in the message by at least one of the following: the indication or the command is associated with an identity of the terminal device; the indication is comprised in the message as an access type; the indication or the command is comprised in the message as a cause; at least one of an identity of an A-IoT device or the command is comprised in a notification list; or at least one of an identity of the terminal device or the command is comprised in the notification list.

In some embodiments, the access network device is caused to transmit the message by: transmitting the message on a physical downlink control channel by means of downlink control information with cyclic redundancy check scrambled by a radio network temporary identity specific to the A-IoT communication; transmitting the message on a physical downlink control channel by means of downlink control information specific to the A-IoT communication; transmitting the message on a physical downlink shared channel scheduled by the downlink control information with cyclic redundancy check scrambled by the radio network temporary identity specific to the A-IoT communication; or transmitting the message on a physical downlink shared channel scheduled by the downlink control information specific to the A-IoT communication.

In some embodiments, the message is a paging message.

In some embodiments, the access network device is further caused to: transmit, to the terminal device in a connected state, a mapping between commands for the A-IoT communication and configuration sets.

In some embodiments, the access network device is further caused to: receive, from the terminal device, a result of the A-IoT communication.

In some embodiments, the access network device is caused to receive the result of the A-IoT communication by: receiving a request for radio resource control connection establishment or resume.

In some embodiments, the request for the radio resource control connection establishment comprises an establishment cause indicating that the radio resource control connection establishment procedure is initiated upon complete of the A-IoT communication. In some embodiments, the request for the radio resource control connection resume comprises a resume cause indicating that the radio resource control connection resume procedure is initiated upon complete of the A-IoT communication.

In some embodiments, the access network device is further caused to: transmit, to the terminal device, an indication indicating that the message is for the A-IoT communication. In some embodiments, the message is a paging message, and the access network device is caused to transmit the indication by at least one of the following: causing the indication to be comprised in a paging record, or causing the indication to be comprised in a paging cause.

In some embodiments, the access network device is further caused to: transmit, to the terminal device, a further indication indicating whether a response to the paging message is to be transmitted; and in accordance with a determination that the further indication indicates that the response is to be transmitted, receive a result of the A-IoT communication from the terminal device.

In another solution, a method of communication comprises: receiving, at a terminal device in an idle or inactive state, a message from an access network device; and in accordance with a determination that the message indicates an ambient Internet of things (A-IoT) communication, initiating, based on the message, the A-IoT communication with a set of A-IoT devices.

In another solution, a method of communication comprises: transmitting, at an access network device and to a terminal device in an idle or inactive state, a message indicating an ambient Internet of things (A-IoT) communication.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 4. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A terminal device comprising:
a processor configured to cause the terminal device to:
receive, in an idle or inactive state, a message from an access network device; and
in accordance with a determination that the message indicates an ambient Internet of things (A-IoT) communication, initiate, based on the message, the A-IoT communication with a set of A-IoT devices.

2. The terminal device of claim 1, wherein the message comprises at least one of the following:
an indication of the A-IoT communication; or
a command for the A-IoT communication.

3. The terminal device of claim 2, wherein the indication or the command is comprised in the message by at least one of the following:
the indication or the command is associated with an identity of the terminal device;
the indication is comprised in the message as an access type;
the indication or the command is comprised in the message as a cause;
at least one of an identity of an A-IoT device or the command is comprised in a notification list; or
at least one of an identity of the terminal device or the command is comprised in the notification list.

4. The terminal device of claim 1, wherein the terminal device is caused to initiate the A-IoT communication by:
in accordance with a determination that an indication of the A-IoT communication or a command for the A-IoT communication is comprised in the message, initiating the A-IoT communication;
in accordance with a determination that a cause for the message indicates the A-IoT communication or the command, initiating the A-IoT communication;
in accordance with a determination that an identity of an A-IoT device comprised in a notification list matches an identity of an A-IoT device managed by the terminal device, initiating the A-IoT communication; or
in accordance with a determination that an identity of the terminal device comprised in a notification list matches an identity of the terminal device allocated by upper layers of the terminal device or assigned by the access network device, initiating the A-IT communication.

5. The terminal device of claim 1, wherein the terminal device is caused to receive the message by:
receiving the message on a physical downlink control channel by means of downlink control information with cyclic redundancy check scrambled by a radio network temporary identity specific to the A-IoT communication;
receiving the message on a physical downlink control channel by means of downlink control information specific to the A-IoT communication;
receiving the message on a physical downlink shared channel scheduled by the downlink control information with cyclic redundancy check scrambled by the radio network temporary identity specific to the A-IoT communication; or
receiving the message on a physical downlink shared channel scheduled by the downlink control information specific to the A-IoT communication.

6. The terminal device of claim 1, wherein the message is a paging message.

7. The terminal device of claim 1, wherein the terminal device is caused to initiate the A-IoT communication by at least one of the following:
initiating an inventory of the set of A-IoT devices; or
performing the A-IoT communication based on a command for the A-IoT communication.

8. The terminal device of claim 1, wherein the terminal device is caused to initiate the A-IoT communication by at least one of the following:
forwarding information of the A-IoT communication from a lower layer to upper layers of the terminal device; or
forwarding, from the lower layer to the upper layers, at least one of an identity of the terminal device, access type or a cause comprised in the message.

9. The terminal device of claim 1, wherein the terminal device is further caused to at least one of the following:
in accordance with a determination that the A-IoT communication is initiated, start a timer;
in accordance with a determination that a feedback is received from the set of A-IoT devices while the timer is running, determine that the A-IoT communication is successfully completed; or
in accordance with a determination that the timer expires, determine that the A-IoT communication is failed.

10. The terminal device of claim 1, wherein the terminal device is caused to initiate the A-IoT communication by:
receiving, from the access network device, a mapping between commands for the A-IoT communication and configuration sets;
in accordance with a determination that a command for the A-IoT communication is received, determining, based on the mapping, a configuration set corresponding to the command; and
initiating the A-IoT communication based on the configuration set.

11. The terminal device of claim 1, wherein the terminal device is further caused to:
transmit a result of the A-IoT communication to the access network device.

12. The terminal device of claim 11, wherein the terminal device is caused to transmit the result of the A-IoT communication by:
in accordance with a determination that the result of the A-IoT communication is determined, initiating a radio resource control connection establishment or resume procedure.

13. The terminal device of claim 12, wherein the terminal device is caused to initiate the radio resource control connection establishment procedure by initiating the radio resource control connection establishment procedure with an establishment cause indicating that the radio resource control connection establishment procedure is initiated upon complete of the A-IoT communication; or
wherein the terminal device is caused to initiate the radio resource control connection resume procedure by initiating the radio resource control connection resume procedure with a resume cause indicating that the radio resource control connection resume procedure is initiated upon complete of the A-IoT communication.

14. The terminal device of claim 1, wherein the terminal device is further caused to:
receive, from the access network device, an indication indicating that the message is for the A-IoT communication; and
determine that the message indicates the A-IoT communication.

15. The terminal device of claim 14, wherein the message is a paging message, and wherein the terminal device is caused to receive the indication by at least one of the following:
receiving the indication in a paging record, or
receiving the indication in a paging cause.

16. The terminal device of claim 14, wherein the terminal device is further caused to:
receive, from the access network device, a further indication indicating whether a response to the message is to be transmitted; and
in accordance with a determination that the further indication indicates that the response is to be transmitted, transmit a result of the A-IoT communication to the access network device.

17. The terminal device of claim 14, wherein the message is a paging message associated with an identity of the terminal device allocated by upper layers of the terminal device and is for the A-IoT communication, and the terminal device is in the idle state, and wherein the terminal device is further caused to:
in accordance with a determination that the A-IoT communication fails and no response to the paging message is to be transmitted, remain in the idle state; or
in accordance with a determination that a response to the paging message is to be transmitted, initiate a radio resource control connection establishment procedure.

18. The terminal device of claim 14, wherein the message is a paging message associated with an identity of the terminal device assigned by the access network device and is for the A-IoT communication, and the terminal device is in the inactive state, and wherein the terminal device is further caused to:
in accordance with a determination that the A-IoT communication fails and no response to the paging message is to be transmitted, remain in the inactive state; or
in accordance with a determination that a response to the paging message is to be transmitted, initiate a radio resource control connection resume procedure.

19. The terminal device of claim 14, wherein the message is a paging message associated with an identity of the terminal device allocated by upper layers of the terminal device and is for the A-IoT communication, and the terminal device is in the inactive state, and wherein the terminal device is further caused to:
in accordance with a determination that the A-IoT communication fails and no response to the paging message is to be transmitted, enter the idle state; or
in accordance with a determination that a response to the paging message is to be transmitted, initiate a radio resource control connection establishment procedure.

20. The terminal device of claim 14, wherein the message is a paging message that is not only for the A-IoT communication, and wherein the terminal device is further caused to:
in accordance with a determination that the paging message is associated with an identity of the terminal device allocated by upper layers of the terminal device and the terminal device is in the idle state, forward information of completion of the A-IoT communication from a lower layer to upper layers of the terminal device;
in accordance with a determination that the paging message is associated with an identity of the terminal device assigned by the access network device and the terminal device is in the inactive state, initiate a radio resource control connection resume procedure; or
in accordance with a determination that the paging message is the paging associated with the identity of the terminal device and the terminal device is in the inactive state, forward the information of completion of the A-IoT communication from the lower layer to the upper layers.
